(19) United States
(12) Patent Application Publication
(10) Pub. No.: US 2024/0112579 A1
(43) Pub. Date: Apr. 4, 2024

(54) BLUETOOTH PARKING ACCESS MANAGEMENT

(71) Applicant: FlashParking, Inc., Austin, TX (US)

(72) Inventors: Juan Fabian Rodriguez, Austin, TX (US); Dean Cleaver, Austin, TX (US); Eliseo Diaz, Austin, TX (US); Carlos Hernandez, Austin, TX (US)

(73) Assignee: FlashParking, Inc., Austin, TX (US)

(21) Appl. No.: 17/959,960

(22) Filed: Oct. 4, 2022

Related U.S. Application Data
(63) Continuation-in-part of application No. 16/657,700, filed on Oct. 18, 2019, now abandoned.
(60) Provisional application No. 62/747,462, filed on Oct. 18, 2018.

(51) Int. Cl. G08G 1/14; G06Q 20/32; G06Q 20/40; G07B 15/04; H04B 17/318; H04W 4/80; H04W 12/06; H04W 12/08; H04W 12/47; H04W 12/64

(52) U.S. Cl. CPC G08G 1/149; G06Q 20/3267; G06Q 20/4014; G06Q 20/40155; G07B 15/04; G08G 1/144; H04B 17/318; H04W 4/80; H04W 12/06; H04W 12/08; H04W 12/47; H04W 12/64; G06Q 2240/00

(57) ABSTRACT

A parking facility access management system having a sensing device communicatively connected to the internet and to a mechanism for providing access to a parking facility. A mobile device is communicatively connected to the sensing device while in proximity to the sensing device, and also communicatively connected to the internet while not in proximity to the sensing device. As the mobile device enters proximity to the sensing device, the mobile device communicates exclusively with the sensing device and not the internet. In some embodiments, as the mobile device enters proximity to the sensing device, the mobile device sends a signal to the sensing device to alert the mechanism for providing access to provide access to the parking facility.

### PRIORITY STATEMENT UNDER 35 U.S.C. § 119 & 37 C.F.R. § 1.78

This non-provisional application is a continuation in part of U.S. patent application Ser. No. 16/657,700 filed Oct. 18, 2019 in the names of Juan Fabian Rodriguez, Dean Alan Cleaver, Eliseo Joaquin Diaz, and Carlos Hernandez entitled “BLUETOOTH PARKING ACCESS MANAGEMENT,” which claims priority based upon prior U.S. Provisional Patent Application Ser. No. 62/747,462 filed Oct. 18, 2018 in the names of Juan Fabian Rodriguez, Dean Alan Cleaver, Eliseo Joaquin Diaz, and Carlos Hernandez entitled “BLUETOOTH PARKING ACCESS MANAGEMENT,” the disclosures of which are incorporated herein in their entirety by reference as if fully set forth herein.

### BACKGROUND OF THE INVENTION

Currently, parking facility operators do not have the ability to seamlessly process customers entering and exiting the parking facility without a parking attendant or an automated parking machine at each entry or exit parking gate. Current methods known for processing a customer entering a parking facility require a customer to stop at a kiosk, roll down their car window, and interact with the system through pulling a ticket or tapping a proximity card, etc. Alternatively, parking facility operators may expend large sums of money to install expensive devices to read toll or similar tags. Depending on the configuration of the parking facility, customers may be required to make a cash or credit card payment. The current process may lead to delays and long queue lines at the gates.

Moreover, many entry and exit kiosks operate by connections to mobile applications through the internet. In such cases, the access mechanisms become inoperable when internet service is unavailable such as in underground facilities, when the weather is a factor, or when internet service is not available.

There is a need, therefore, for a method and system that allows parking operators to automatically process entering and exiting customers, and vend the facility gate, without requiring the customer to manually interact with the kiosk, and with service availability in the absence of internet connectivity.

### SUMMARY OF THE INVENTION

Embodiments of the present invention relate generally to the methods and systems for improved parking facility ingress and egress. More specifically, a parking facility access management system comprises a sensing device communicatively connected to the internet and also to a mechanism for providing access to the facility. A mobile device is communicatively connected to the sensing device while in proximity to the sensing device, and also communicatively connected to the internet.

In some embodiments, as the mobile device enters proximity to the sensing device, the mobile device sends a signal to the sensing device to alert the mechanism for providing access to provide access to the parking facility. In some instances, when the mobile device sends a signal to the sensing device, the sensing device will first confirm the mobile device's credentials and, when confirmed, the sensing device alerts the mechanism for providing access to provide access to the parking facility. In other instances, when the mobile device sends a signal to the sensing device, the sensing device will first confirm receipt of payment and, when confirmed, the sensing device alerts the mechanism for providing access to provide access to the parking facility

The Bluetooth access system of the present invention allows parking facility operators to offer their customers a seamless, touch-free experience. Various embodiments utilize a combination of the sensing device, Bluetooth technology, and mobile devices, which include a vehicle's head unit, to detect customers upon entry and exit of a parking facility and verify the customer's access credentials without requiring any action on the customer's part at the time of entry or egress. In some embodiments, a credit card on-file will be utilized to collect payment.

In various embodiments of the invention, a user downloads an application onto a mobile device and sets up an account through the application. The registration may include only the name and contact information (e.g., phone number or email address of the user) and may optionally also include information regarding the user's vehicle. In addition, the user may register for all uses or specific uses only, such as, for example, contract parking, transient parking, paying on demand, or transient parking with the ability to make a reservation and pre-pay for parking in advance.

Once the application has been loaded on the mobile device, the device is able to communicate through Bluetooth connectivity with a sensing device located at a parking facility. As a result, the system of the present invention will work even in situations or environments when connectivity through the cloud isn't possible, such as when the sensing device is located in a basement parking facility where cellular service is unavailable.

In the application, a user may, for example, find a parking facility, make a reservation at a parking facility, and prepay for a parking session at a parking facility. In some instances, a user may select a parking facility connected to the payment system of the present invention, designate a date and time of arrival and departure, and prepay parking fees through the application. In some embodiments, a list of reservations will be displayed through the application. Once the user retrieves that reservation, a button or other icon will be presented in the application which allows the user to enter or exit the parking facility.

A sensing device may be located at each entry and exit lane at a parking facility; and, in many instances, the equipment may be combined into a single device and located to operate both an exit and entry lane of the facility. The sensing device is communicatively connected to a mechanism for restricting access to the parking facility, such as an entry/exit gate, and also communicatively connected to the application through the cloud. When a parker approaches a sensing device, the mobile device is authenticated based on credentials stored in the cloud. If multiple registered mobile devices are in proximity to a single sensing device, the application may, for example, provide a notice to each of the users requiring them to designate which application is responsible for making the applicable payment.

In some instances, it may be desirable to include inductive loops at the entry area to ensure the vehicle is near the parking gate prior to vending the gate, thereby preventing the wrong vehicle from trying to enter or exit the parking facility.

Typical sensing devices, such as the iBeacon, broadcast signals through a 360 degrees rotation. However, embodiments of the present invention broadcast signals over a 180 degree or less arc, which provides the ability to confine the devices' detection area to a single parking lane.

In addition to identifying a specific lane to which a directional Bluetooth signal is broadcasting, methods of ranging using Bluetooth can be used to infer distance. One way in which this is performed is from the receiving end using what is called the Received Signal Strength Indication (“RSSI”). This is a measurement, calculated in dBm (decibel-milliwatts) units, for the power present in the radio signal received from the broadcasting Bluetooth transmitter.

A RSSI is a negative value where the more negative it is, the further away the Bluetooth signal. Close devices are usually in the range −10 dBm to −30 dBm while devices at the limit of detection give values less than −90 dBm.

Based on the fluctuation of radio signals, one may be able to establish a fairly accurate result of the RSSI trending. Accordingly, one may then determine if the signal is getting stronger or weaker, and therefore, if the receiving device is moving towards or away from the transmitting beacon.

However, the relationship between RSSI and distance is not linear and depends on electrical, physical, and environmental factors. The largest electrical factor is the radio signal's transmission power; however, physical factors that may affect the RSSI include blocking and reflection.

As the physical environment in which the radio signal is transmitted affects the RSSI determined by the receiver, it may be advantageous to calibrate the signal being transmitted that is used to establish the RSSI, in order to facilitate more accurate RSSI determinations, and therefore more accurate ranging, by the receiving device.

In the case at hand, the receiving device that determines the RSSI from an inbound radio signal in order to perform ranging between said receiving device and the transmitter is the mobile device. The transmitter is the directional Bluetooth transmitter, and the signal being used to determine the RSSI is the first signal. More specifically, various RSS values transmitted as part of the first signal may be used as the signal for determining the RSSI value, and therefor proximity between the mobile device and the sensing device.

Accordingly, in embodiments, it may be advantageous to calibrate at least the RSS signal(s) transmitted by the directional Bluetooth transmitter(s) of the sensing device to the in-situ environment of the parking facility in which the sensing device is installed, so that the physical factors that may affect the RSSI value may be mitigated, and that the RSSI determined from such RSS signal(s) may provide for as accurate ranging as possible.

Another issue with the determination of a consistent RSSI value could be inconsistencies between hardware/radio platforms being used. For instance, on iOS devices where there are not many different chipsets, the RSSI value could accurately reflect the relationship to the distance. The RSSI value from iPhone A probably means the same strength value on an iPhone B. However, on Android devices where we have a large variation of devices and chipsets, the absolute value of RSSI may similarly have significant variation. The same RSSI value on two different Android phones with two different chipsets may mean two different signal strengths. However, the RSSI value could still be very helpful in the proximity applications if you use it to get the trend of the RSSI value change. That trend could give you meaningful data.

Accordingly, it may be advantageous to utilize RSSI-based ranging methods that use RSSI trend data rather than instantaneous RSSI data in order to make determinations regarding proximity/ranging.

In addition, or in the alternative, it may be advantageous for the first signal to include a plurality of RSS signals, each of which may be calibrated to a different hardware device or chipset. In such embodiments, the mobile device may identify the appropriate RSS value for its hardware and may perform the RSSI-based ranging using an RSSI value based off of the identified appropriate RSS value

In some embodiments it may be desirable to add an enclosure around the sensing device, such as a glass or plastic cover, to ensure to directionality of the Bluetooth signal. This ensures that in a parking facility with multiple entry lanes, the signal is only directed to a single lane and there is not overlap of the signal onto adjoining lanes. The power setting on the sensing device may be adjusted to assist in determining the location of the vehicle and whether the vehicle is in the designated lane.

In one embodiment of the present invention is a parking facility access management system comprises a sensing device communicatively connected to the internet and to a mechanism for providing access to a parking facility; a mobile device communicatively connected to the sensing device while in proximity to the sensing device, and communicatively connected to the internet while not in proximity to the sensing device; wherein as the mobile device enters proximity to the sensing device, the mobile device communicates exclusively with the sensing device and not the internet. In some embodiments, as the mobile device enters proximity to the sensing device, the mobile device sends a signal to the sensing device to alert the mechanism for providing access to provide access to the parking facility. Alternatively, as the mobile device enters proximity to the sensing device, the mobile device sends a signal to the sensing device and, if the sensing device can confirm the mobile device's credentials, the sensing device alerts the mechanism for providing access to provide access to the parking facility, or, as the mobile device enters proximity to the sensing device, the mobile device sends a signal to the sensing device and, if the sensing device receives payment information from the mobile device, the sensing device alerts the mechanism for providing access to provide access to the parking facility.

Various embodiments of the parking system of the present invention may be manifested in a variety of configurations. Several specific examples, which should not be considered limiting, follow below.

### EXAMPLE 1

### Bluetooth Access for Contract Parkers

In one embodiment, the parking system of the present invention may be configured to provide a nonstop entering and exiting experience for a registered contract parker. The contract parker downloads the application onto his or her mobile device. They would then provide registration information through the application, and the registration information would include information regarding the parking facility designated by the contract parker and the terms of the contract governing the agreed-upon arrangement for parking.

When the contract parker arrives at the entry gate of the designated parking facility during the contract term, the sensing device communicates with the mobile device through Bluetooth to determine the proximity of the mobile device to the sensing device. The sensing device then communicates through the internet to the cloud to verify, using the registration information and the terms of the contract, the contract parker's right to access the facility. Upon verification, the sensing device will open the gate to allow the contract parker access to the parking facility.

### EXAMPLE 2

### Bluetooth Access for Transient Parkers with a Prepaid Reservation

In another embodiment of the present invention, the parking system of the present invention may be configured to provide a nonstop entering and exiting experience for a transient parker on a prepaid basis. The transient parker downloads the application onto his or her mobile device. They would then provide registration information through the application, and the registration information would include information regarding the parking facilities available for parking by the transient parker and would also include the ability to pre-pay for parking at the available facilities.

When the transient parker arrives at the entry gate of one of the available parking facilities, the sensing device communicates with the mobile device through Bluetooth to determine the proximity of the mobile device to the sensing device. The sensing device then communicates through the internet to the cloud to verify, using the registration information, the transient parker's right to access the facility. Upon verification, the sensing device will open the gate to allow the transient parker access to the parking facility. When the transient parker leaves the parking facility, the sensing device communicates through the internet to the cloud to provide information regarding the parking fees owed by the transient parker, and that amount is debited from his or her prepaid account.

### EXAMPLE 3

### Bluetooth Access for Transient Parkers

In yet another embodiment of the present invention, the parking system of the present invention may be configured to provide a nonstop entering and exiting experience for a transient parker who is charged at the time of use. Once again, the transient parker downloads the application onto his or her mobile device. They would then provide registration information through the application, and the registration information would include information regarding the parking facilities available for parking by the transient parker and would also include credit card, debit card, PayPal or another payment method to be used to pay parking fees.

When the transient parker arrives at the entry gate of one of the available parking facilities, the sensing device communicates with the mobile device through Bluetooth to determine the proximity of the mobile device to the sensing device. The sensing device then communicates through the internet to the cloud to verify, using the registration information, the transient parker's right to access the facility. Upon verification, the sensing device will open the gate to allow the transient parker access to the parking facility. When the transient parker leaves the parking facility, the sensing device communicates through the internet to the cloud to provide information regarding the parking fees owed by the transient parker, and that amount is paid using the payment method designated by the parker.

Those skilled in the art will appreciate the numerous features and advantages offered by the various embodiments of the present invention. For example, once the parker has registered through the application, they can quickly and easily access a parking facility without pairing the Bluetooth to the sensing device. Also, importantly, because the mobile device is connected by Bluetooth to the sensing device, the mobile device does not need access to a cellular carrier or internet for the entry or exit transaction to take place. This allows for the use of the parking system of the present invention in remote areas or underground areas where cellular service and internet service are spotty or unavailable.

From the parking facility's perspective, one significant benefit is that each sensing device may be individually adjusted to provide optimal performance in each lane. Also, there is no need for an expensive toll tag reader for each lane and no need for active or passive tags. Therefore, the cost of implementation is minimal compared to all of the hardware and tags that are needed with systems that are commonly available today.

The present invention is directed to improved methods and systems for, among other things, parking systems. The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiments disclosed provide many applicable inventive concepts that can be embodied in a wide variety of contexts other than parking systems and may be readily utilized as a basis for modifying or designing other structures or processes for carrying out the same purposes of the present invention. It should also be realized by those skilled in the art that the specific embodiments discussed are merely illustrative of specific ways to make and use the invention, and do not limit the scope of the invention, and that such equivalent constructions do not depart from the spirit and scope of the invention as set forth in the claims.

### DESCRIPTION OF THE DRAWINGS

For a more complete understanding of the present invention, and the advantages thereof, reference is now made to the following descriptions taken in conjunction with the accompanying drawings, in which:

FIG. 1 shows a block diagram of a basic embodiment of a parking facility access management system wherein the sensing device is integrated into a kiosk.

FIG. 2 shows a block diagram of a more complex embodiment of a parking facility access management system wherein the sensing device is integrated into a kiosk along with additional peripheral components of the kiosk, and wherein the sensing device comprises a plurality of Bluetooth transceivers.

FIG. 3 shows a block diagram of an embodiment of a parking facility access management system comprising a remote presence detector and showing its relationship to an ingress/egress lane of the parking facility, and an application running on a user's mobile device.

FIG. 4 shows a block diagram of an embodiment of the parking facility access management system as shown in FIG. 3 and the connection between the constituent components thereof.

FIG. 5 depicts a pair of the exemplary parking facility access management systems depicted in FIG. 3, wherein each of the parking facility access management systems is associated with an associated ingress/egress lane of the parking facility.

FIG. 6 depicts an exemplary parking facility access management system wherein the sensing device comprises a plurality of directional Bluetooth transmitters and is remote from the kiosk(s), and wherein the single sensing device is configured to facilitate the operation of a plurality of parking facility ingress/egress lanes.

FIG. 7 depicts a block diagram of an embodiment of the parking facility access management system depicted in FIG. 6 and the connections between constituent components thereof.

FIGS. 8A-B show an exemplary flow diagram depicting an embodiment of the signal flow between the components of an exemplary parking facility access management system.

FIGS. 9A-B show an exemplary flow diagram depicting an embodiment of the signal flow between the components of an exemplary parking facility access management system, such as the parking facility access management system depicted in FIG. 3, wherein the parking facility access management system is communicating with a plurality of applications operating on a plurality of user devices.

FIGS. 10A-B show an exemplary flow diagram depicting an embodiment of the signal flow between the components of an exemplary parking facility access management system, wherein the user of the application requests and receives a pre-authorization to access the parking facility.

### DESCRIPTION OF THE PREFERRED EMBODIMENTS

The present invention is directed to improved methods and systems for, among other things, parking access management. The configuration and use of the presently preferred embodiments are discussed in detail below. It should be appreciated, however, that the present invention provides many applicable inventive concepts that can be embodied in a wide variety of contexts other than the specific types of parking ingress and egress management described herein. Accordingly, the specific embodiments discussed are merely illustrative of specific ways to make and use the invention, and do not limit the scope of the invention. In addition, the following terms shall have the associated meaning when used herein:
“application” is a software program designed to run on a mobile device;
“Bluetooth transceiver” means a two-way hardware Bluetooth device capable of both receiving data and transmitting data, generally in an omnidirectional manner;
“directional Bluetooth transmitter” means a one-way hardware Bluetooth device capable of transmitting data in a limited ark about the device, but not capable of receiving data;
“cloud” means a collection of logical devices which may or may not include underlying physical servers, wherein all such logical devices may be accessed without any knowledge, or with limited knowledge, of the underlying physical devices, and wherein the collection of logical devices has persistent logical resources, but is non-deterministic in its use of physical resources;
“head unit” means a hardware and software interface integrated into a vehicle such as a car or truck that gives the user control over the vehicle's information and entertainment media, such as AM/FM radio, satellite radio, dash cams, GPS navigation, Bluetooth, Wi-Fi and the like;
“mobile device” means any portable computing device, typically having a display screen with touch input and/or a miniature keyboard, and includes, without limitation, the head unit;
“parking facility” means an indoor or outdoor area for parking vehicles, including, for example, a parking garage, parking lot, parking ramp, car park and the like; and
“sensing device” means a system comprising both at least one directional Bluetooth transmitter and at least one Bluetooth transceiver.

In embodiments, a sensing device may be built into each kiosk of the parking facility. In such embodiments, it may be advantageous for such integrated sensing devices to each comprise both a directional Bluetooth transmitter broadcasting a signal having an identifier associated with the same lane in with which the kiosk is associate, and a Bluetooth transceiver.

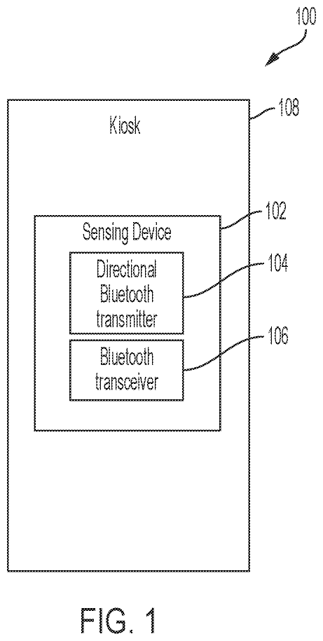

FIG. 1 shows a block diagram of a basic embodiment of a parking facility access management system 100 wherein the sensing device 102, comprising directional Bluetooth transmitter 104 and Bluetooth transceiver 106, is integrated into a kiosk 108.

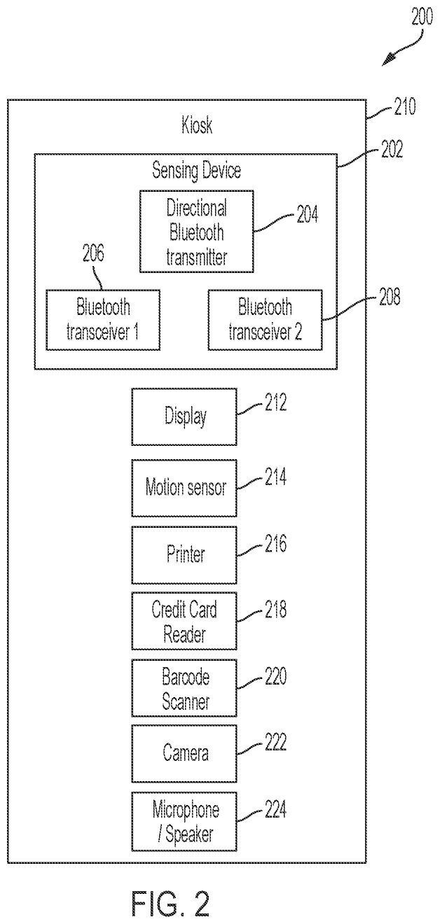

FIG. 2 shows a block diagram of a more complex embodiment of a parking facility access management system 200 wherein the sensing device 202 is integrated into a kiosk 210 along with additional peripheral components of the kiosk 210, including display 212, motion sensor 214, printer 216, credit card reader 218, barcode scanner 220, camera 222, and microphone/speaker 224. Furthermore, in the embodiment of the parking facility access management system depicted in FIG. 2; namely parking facility access management system 200, sensing device 202 comprises a plurality of Bluetooth transceivers; namely Bluetooth transceiver 1 206 and Bluetooth transceiver 2 208, in addition to directional Bluetooth transmitter 204.

Embodiments of parking facility access management systems with multiple Bluetooth transceivers, such as that shown in FIG. 2, may be advantageous in situations when a single sensing device may be required to connect to a multiple user application running on different mobile devices. In such situations, each of the plurality of Bluetooth transceivers may be available to connect to a different application running on a different device. That way, the system for parking facility access management 200 may be able to communicate independently and concurrently with each such application. For example, if a vehicle entering a lane of the parking facility has two occupants, each of whom possesses the application on their phone, sensing device 202 may connect to the first occupant's mobile device via Bluetooth transceiver 1 206 and the second occupant's mobile device via Bluetooth transceiver 2 208. The system may then be able to send each a message to each of the two mobile devices with a request to identify which of the applications should be used to process the transaction. The occupants may then indicate the preferred transactor via input to the application such as by pressing a button indicating the transacting party. Responsive to an input from one or both mobile devices, parking facility access management system 200 may determine which of the applications with which to communicate for the remaining steps of the transaction.

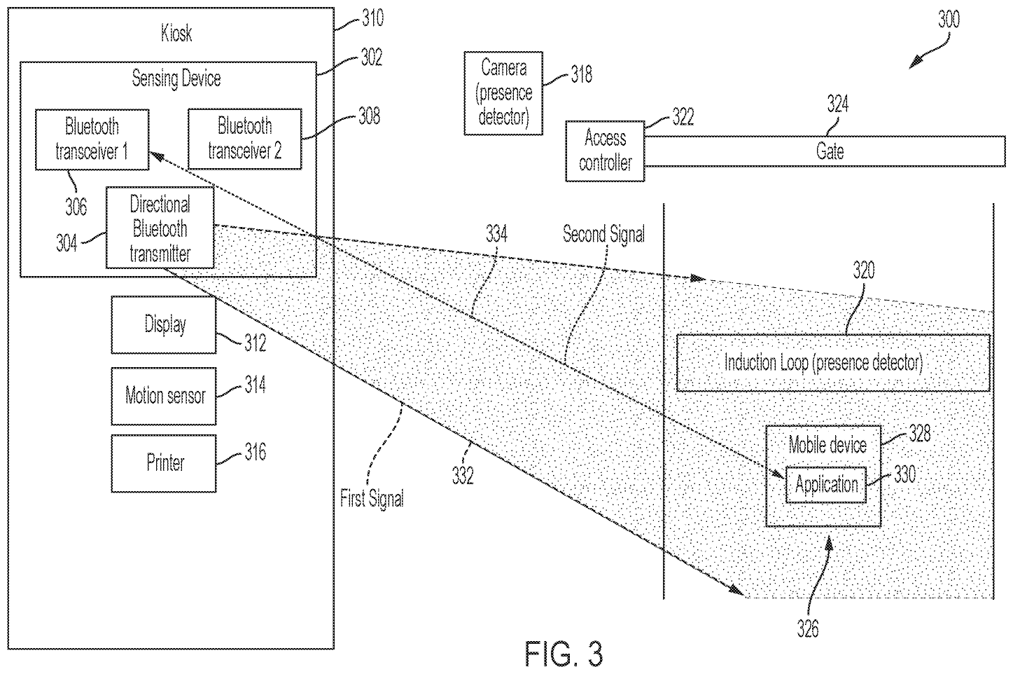

FIG. 3 shows an embodiment of a parking facility access management system, system 300, with a sensing device 302 comprising a plurality of Bluetooth transceivers (Bluetooth transceiver 1 306 and Bluetooth transceiver 2 308), similar to the embodiment shown in FIG. 2. FIG. 3 depicts how directional Bluetooth transmitter 304 may transmit first signal 332 to an application 330 running on a mobile device 328 located in lane 326 of a parking facility. first signal 332 may be directionally limited such that it broadcasts to lane 326 and no other lane in the parking facility. Responsive to the receipt of first signal 332, Application 330 may transmit second signal 334 to one or more of the Bluetooth transceivers of sensing device 302. As depicted in FIG. 3, second signal 334 may be transmitted to Bluetooth transceiver 1 306. If the system determines that the account running on application 330 and sending second signal 334 is properly authorized it may instruct access controller 322 to actuate gate 324 in order to permit the possessor of mobile device 328 access to, or egress from, the parking facility.

In addition to sensing device 302, kiosk 310 may comprise additional peripheral devices, such as but not limited to display 312, motion sensor 314, and printer 316.

Embodiments, such as that shown in FIG. 3, may comprise one or more presence detector(s) to determine or corroborate the presence of a vehicle in a location designated as being relevant to the parking facility access management system. In the embodiment depicted, such presence detector(s) are remote from kiosk 310 and include induction loop 320 and camera 318.

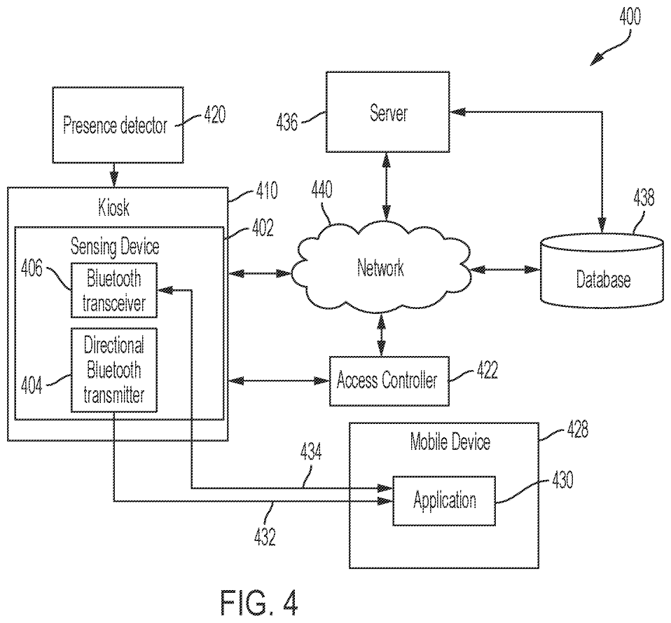

FIG. 4 shows a block diagram of an embodiment of the parking facility access management system and the connection between the constituent components thereof. Parking facility access management system 400 comprises sensing device 402 comprising Bluetooth transceiver 406 and directional Bluetooth transmitter 404. Sensing device 402 is inside of kiosk 410, which is communicably connected to presence detector 420 and access controller 422. Kiosk 410 is also communicably connected to server 436 and database 438 via a suitable communications network 440. Application 430 may run on mobile device 428 and may be configured to receive first signal 432 from directional Bluetooth transmitter 404, to connect to Bluetooth transceiver 406, and to transmit second signal 434 thereto.

In embodiments, database 438 may be directly connected to server 436.

In embodiments, one or more of presence detector 420 and access controller 422 may be communicably connected to sensing device 402 via network 440.

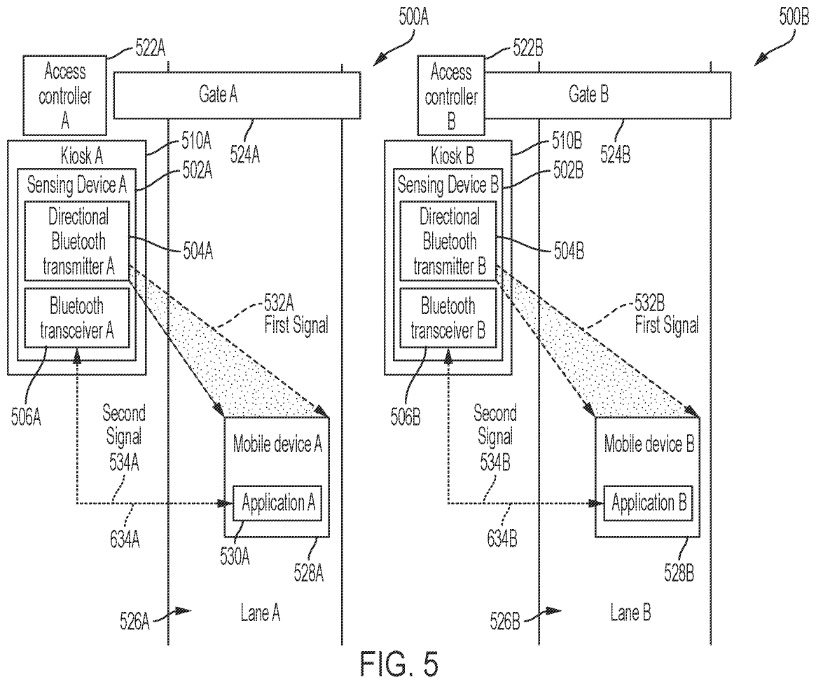

FIG. 5 shows a block diagram of two exemplary parking facility access management systems operating in parallel, systems 500A/B, wherein a plurality of kiosks 510A/B, each comprising its own sensing device 502A/B, is paired with its own, separate, lane 526A/B of the parking facility. In such embodiments, directional Bluetooth transmitter 504A may be configured and tuned to broadcast first signal A 632A only to its associated lane 526A, while directional Bluetooth transmitter 504B may be configured and tuned to broadcast first signal B 632B only to its associated lane 526B. Accordingly, application A 530A may transmit second signal A 634A, comprising an identifier associated with lane A 526A, to Bluetooth transceiver A 506A responsive to its receipt of first signal A 632A, and application B 530B may transmit second signal B 634B, comprising an identifier associated with lane B 526B, to Bluetooth transceiver B 506B responsive to its receipt of first signal B 632B.

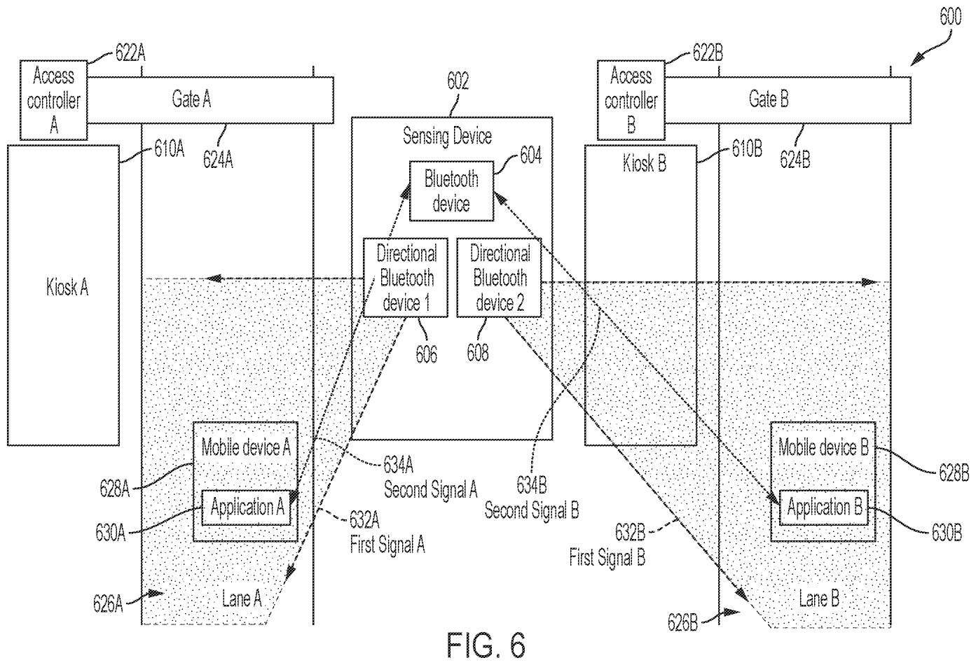

In alternate embodiments, a sensing device may be separate from the kiosk of the parking facility. In some such embodiments, it may be beneficial for the parking facility management system to have a single sensing device comprising a Bluetooth transceiver and a plurality of directional Bluetooth transmitters, wherein each of the plurality of directional Bluetooth transmitters are associated with a separate ingress and/or egress lane of the parking facility. In such embodiments, each of the plurality of directional Bluetooth transmitters broadcast a different identifier each of which is associated with the lane to which its respective directional Bluetooth transmitter is itself associate. Such an embodiment of a parking facility access management system is depicted in FIG. 6 and discussed hereinbelow.

FIG. 6 shows an alternative embodiment of a parking facility access management system; namely system 600, wherein a single sensing device 602 is separate from either kiosk A 610A or kiosk B 610 B and comprises a plurality of directional Bluetooth devises (directional Bluetooth transmitter 1 606 and directional Bluetooth transmitter 2 608) in addition to Bluetooth transceiver 604, so that sensing device 602 may be used to control multiple parking facility ingress/egress lanes. In such embodiments each of the directional Bluetooth transmitters 606 and 608 may broadcast a unique first signal to a lane with which that particular directional Bluetooth transmitter is associated. For example, as shown in FIG. 6, directional Bluetooth transmitter 1 606 may transmit first signal A 632A to lane A 626A, while directional Bluetooth transmitter 2 608 may transmit first signal B 632B to lane B 626B. First signal A 632A and first signal B 632B may comprise different components from one another; including, for example different lane identifiers. That way when application A 630A running on mobile device A 628A responds to its receipt of first signal A 623A by sending second signal A 634A to Bluetooth transceiver 604 it may inform sensing device 602 the appropriate lane, gate, or access controller for which it is requesting access (here access controller A 622A and gate A 624A for lane 626A); and similarly, when application B 630B running on mobile device B 628B responds to its receipt of the first signal that it detects (namely first signal B 632B) by sending second signal B 634B to Bluetooth transceiver 604 it may inform sensing device 602 the appropriate lane, gate, or access controller for which it is requesting access (here access controller B 622B and gate A 624B for lane 626B).

In such embodiments, each lane of the parking facility may have an associated presence detector, such as presence detector A 620A being associated with lane A 626A, and presence detector B 620B being associated with lane B 626B, in order to corroborate the presence of a vehicle in the associated lane.

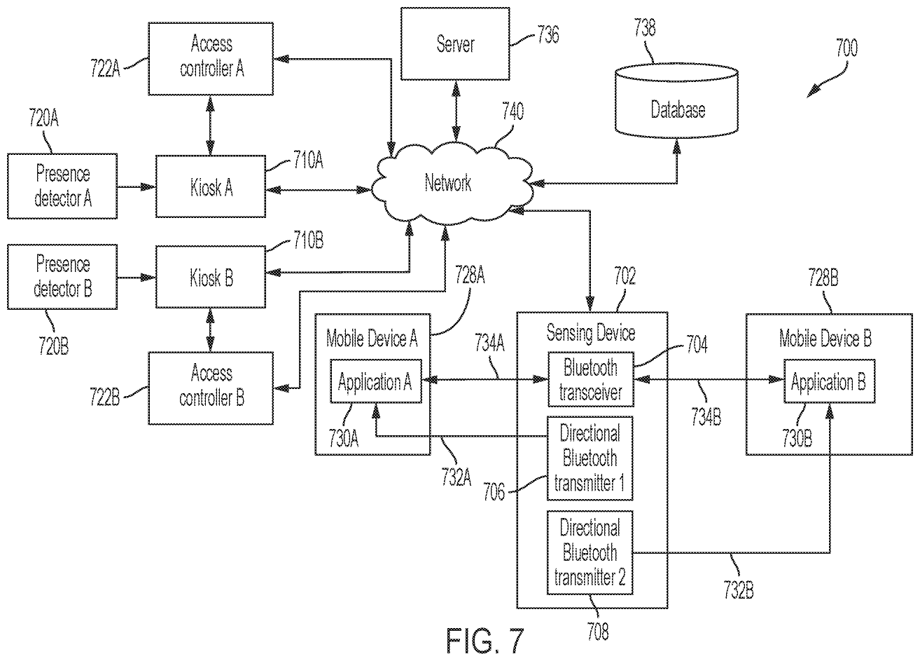

FIG. 7 shows a block diagram of an embodiment of the parking facility access management system as shown in FIG. 6 and the connection between the constituent components thereof. In parking facility access management system 700 sensing device 702, comprising Bluetooth transceiver 704 and a plurality of directional Bluetooth transmitters; namely directional Bluetooth transmitter 1 706 and directional Bluetooth transmitter 2 708, is a standalone unit (i.e., not integrated into a kiosk associated with a single lane of the parking facility). Sensing device 702 may be communicably connected to network 740, which may also be communicably connected to kiosk A 710A, kiosk B 710B, server 736, and database 738. Presence detector A 720A and access controller A 722A may be communicably connected with kiosk A 710A. Similarly, presence detector B and access controller B may be communicably connected to kiosk B 710B.

Sensing device 702 may be configured such that directional Bluetooth transmitter 1 706 may transmit first signal A 732A to a first lane of the parking facility, and to transmit first signal B 732B to a second lane of the parking facility. Assuming mobile device A 728A is located in the first lane of the parking facility, application A 730A may be positioned and configured to receive first signal A 732A from directional Bluetooth transmitter 1 706. Application A 730A may further be configured to connect to Bluetooth transceiver 704 and to transmit second signal A 734A to Bluetooth transceiver 704 responsive to the receipt of first signal A 732A. Similarly, assuming mobile device B 728B is in the second lane of the parking facility, application B 730B may be positioned and configured to receive first signal B 732B from directional Bluetooth transmitter 2 708. Application B 730B may further be configured to connect to Bluetooth transceiver 704 and to transmit second signal B 734B to Bluetooth transceiver 704 responsive to the receipt of first signal B 732B.

In embodiments, one or more of access controller A/B 722A/B may be communicably connected to their respective kiosk A/B 710A/B via network 740.

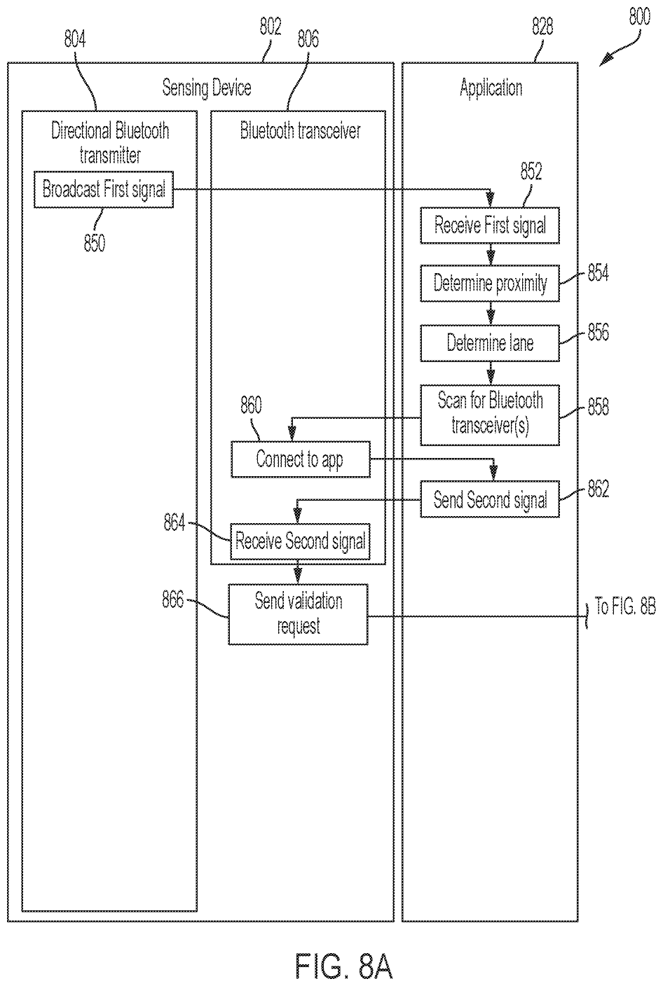

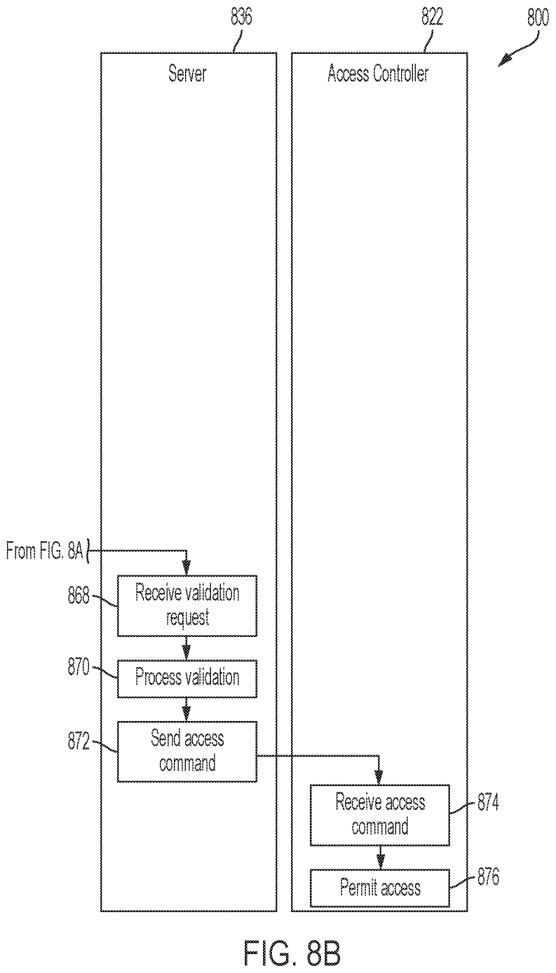

FIGS. 8A-B show an exemplary flow diagram depicting an embodiment of the signal flow between the components of an exemplary parking facility access management system during an embodiment of its operation.

In FIGS. 8A-B, method 800 comprises broadcasting 850 of the first signal by a directional Bluetooth transmitter 804. After receiving 852 the first signal, application 828 may decode the RSS and tuning values included in the first signal in order to determine 854 a proximity of the application 828 to the sensing device 802 and may determine 856 a lane of the parking facility with which the first signal is associated via a lane identifier in said first signal. The application 828 may also be configured to scan 858 for one or more Bluetooth transceiver(s) with which to connect responsive to its receiving 852 the first signal. Bluetooth transceiver 806 may connect 860 to application 828 and application 828 may then send 862 a second signal to Bluetooth transceiver 806, and Bluetooth transceiver 806 may receive 864 said second signal. Responsive to its receipt of the second signal from the application 828, sensing device 802 may send 866 a validation request to server 836, and server 836 may receive 686 said validation request. Once received, server 836 may process 870 the validation request and send 872 an access command to access controller 822 responsive thereto. Access controller 822 may receive 874 the access command from server 836 and may permit 876 access to/from the parking facility responsive thereto. Alternatively, if the access credentials from application 830 transmitted as part of second signal sent from application 828 to Bluetooth transceiver 806 and transmitted as part of the validation request transmitted form sensing device 802 to server 836 fail to meet the authorization level required by the system, then server 836 may not send 872 access command to access controller 822 in which case access controller 822 may not actuate.

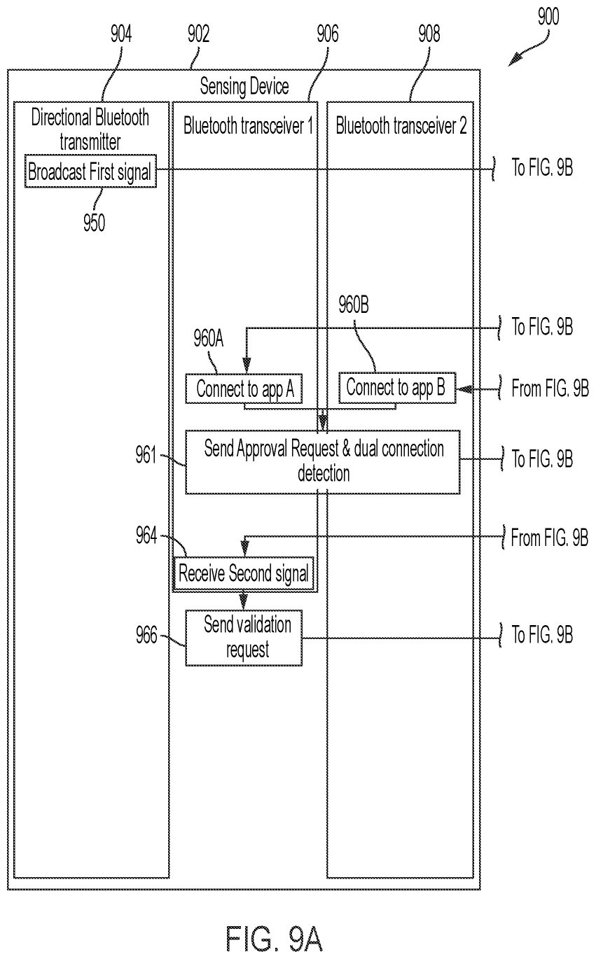

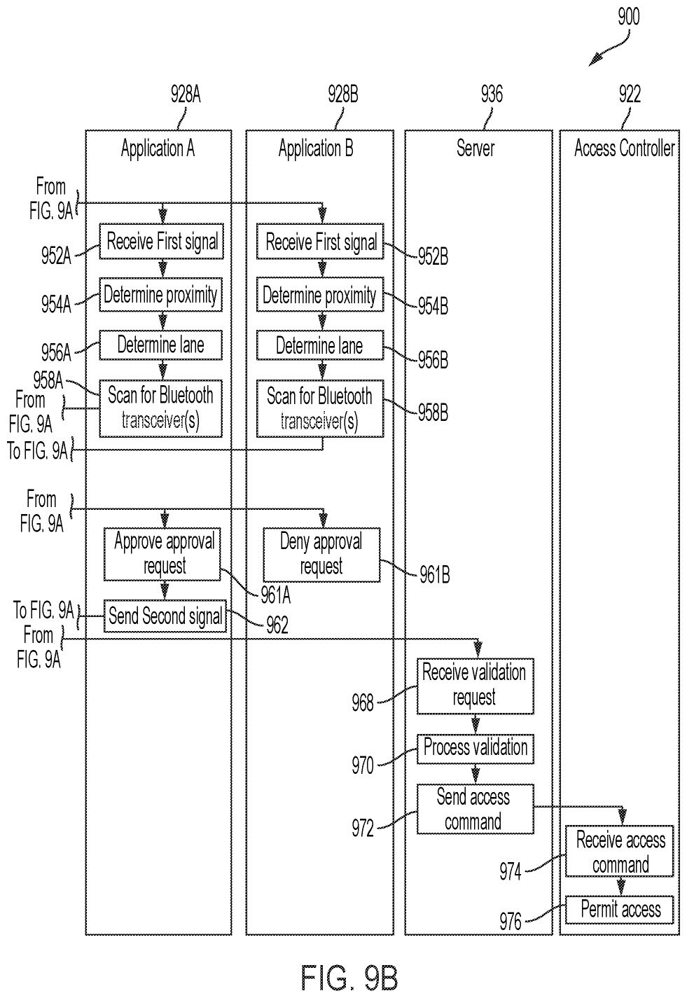

FIGS. 9A-B show an exemplary flow diagram depicting an embodiment of the signal flow between the components of an exemplary parking facility access management system, such as the parking facility access management system depicted in FIG. 3, wherein the parking facility access management system is communicating with a plurality of applications operating on a plurality of user devices, such as when multiple users of the system, with their respective application running on their respective mobile devices, are collocated in the same vehicle.

In FIGS. 9A-B, method 900 comprises broadcasting 950 first signal from directional Bluetooth transmitter 904 and receiving 952A/B first signal at both application A 982A and application B 928B. After receipt of first signal from Bluetooth transmitter 904, both application A 928A and application B 928B perform the steps of determining 954A/B a proximity between the application and sensing device 902, such as by using a RSSI-based ranging method; determining 956A/B a lane of the parking facility based on the lane identifier signal included in first signal; and scan 958A/B for Bluetooth transceivers in range using the tuning value(s) include in first signal. Once applications A/B 928A/B have performed each of these steps they may connect to one of the Bluetooth transceivers 906/908 of sensing device 902. In the embodiment depicted in FIGS. 9A-B, Bluetooth transceiver 1 906 may connect 960A to application A 928A and Bluetooth transceiver 2 908 may connect 960B to application B 928B. Once both applications 928A/B are connected to sensing device 902, sensing device 902 may send 961 an approval request to each of applications 928A/B via Bluetooth transceivers 1 and 2 906, 908. Responsive to receipt of the approval request from sensing device 902 the users of applications 928A/B may input their response to the approval request with an approval or a denial. In method 900, application B 928B denies 961B the request while application A 928 A approves 961A the request. The application that approves the approval request, here application A 928A, may then send 962 a second signal to the Bluetooth transceiver with which it had connected, here Bluetooth transceiver 1 906. Responsive to Bluetooth transceiver 1 906 receiving the second signal from application A 928A sensing device 902 may send 966 a validation request to server 936. Server 936 may receive 968 the validation request, process 970 the validation request, and then if the processing 970 of the validation request indicates that application A 928A possesses requisite authorization, server 936 mat send 972 an access command to access controller 922. Upon receiving 974 the access command form server 936, access controller 922 may permit 976 ingress/egress of the parking facility.

In embodiments, the second signal may comprise authorization credentials, and the step of processing 970 the validation request at server 936 may include validating the authorization credentials provided by application A 928A in the second signal against a database of accounts with approval to enter/exit the parking facility.

In embodiments, method 900 may not require either application 928A/B to actively deny the approval request sent by the sensing device 902, such as in step 961B, but may instead simply rely on an approval of the approval request by one of the applications 928A/B, such as approval 961A in order to proceed to the next step of the method.

In embodiments, the transmission of information between sensing device 902 and applications 928A/B may be performed in either a serial or parallel format; although, it may be advantageous to use a parallel format if the sensing device comprises a plurality of Bluetooth transceivers, as is shown in method 900.

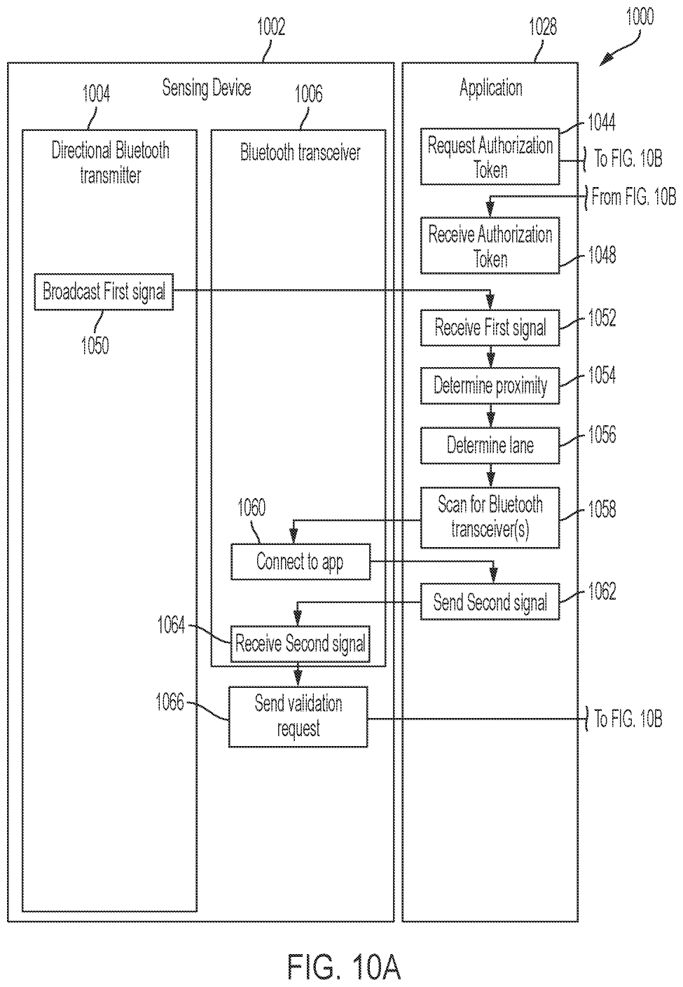

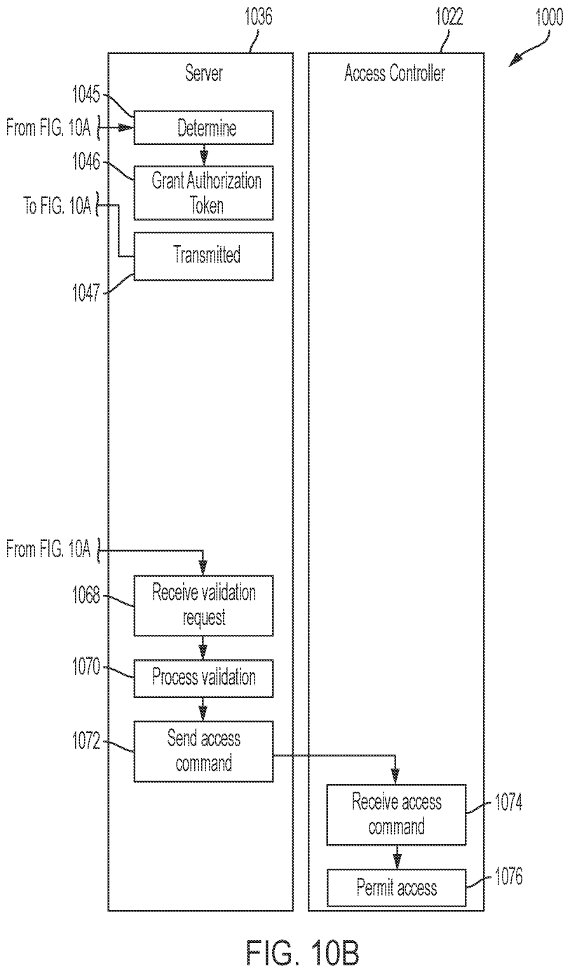

FIGS. 10A-B show an exemplary flow diagram depicting an embodiment of the signal flow between the components of an exemplary parking facility access management system, wherein the user of the application requests and receives a pre-authorization to access the parking facility.

In FIGS. 10A-B, method 1000 comprises application 1028 requesting 1044 an authorization token from server 1036. Upon receipt of the request sent by application 1028 server 1036 may perform the step of determining 1045 whether said request, or the user account associated with application 1028, contains suitable authorization and/or payment information to allow for application 1028 to receive an authorization token for the access it is requesting. Responsive to a positive determination at step 1045, server 1036 may grant 1046 an authorization token responsive to requesting 1044. After server 1036 grants 1046 an authorization token, the authorization token may be transmitted 1047 from server 1036 and received 1048 by application 1028. This pre-authorization process of application 1028 requesting 1044 and server 1036 may be used to pre-pay for parking at a parking facility.

In embodiments, the step of determining 1045 may be performed via comparison of the information included in the request transmitted from application 1028 against information from the account associated with application 1028 stored on a database communicably connected to server 1036.

After the pre-authorization steps discussed above, method 1000 mirrors method 800 in that method 1000 comprises broadcasting 1050 of the first signal by a directional Bluetooth transmitter 1006. After receiving 1052 the first signal, application 1028 may decode the RSS and tuning values included in the first signal in order to determine 1054 a proximity of the application 1028 to the sensing device 1002 and may determine a lane of the parking facility with which the first signal is associated via a lane identifier in said first signal. The application 1028 may also be configured to scan 1058 for Bluetooth transceivers with which to connect responsive to its receiving 1052 the first signal. Bluetooth transceiver 1006 may connect to application 1028 and application 1028 may then transmit 1062 a second signal to Bluetooth transceiver 1006, and Bluetooth transceiver 1006 may receive 1064 said second signal. Responsive to its receipt of the second signal from the application 1028, sensing device 1002 may send 1066 a validation request to server 836, and server 836 may receive 686 said validation request. Once the validation request is received 1068, server 1036 may process 1070 the validation request and send 1072 an access command to access controller 1022 responsive thereto. Access controller 1022 may receive 1074 the access command from server 1036 and may permit 1076 access to/from the parking facility responsive thereto. Alternatively, if the access credentials from application 1028 transmitted as part of second signal sent from application 1028 to Bluetooth transceiver 1006 and transmitted as part of the validation request transmitted form sensing device 1002 to server 1036 fail to meet the authorization level required by the system, then server 1036 may not send 1072 access command to access controller 1022 in which case access controller 1022 may not cause its associated gate to actuate.

One manner in which the embodiment of method 1000 may differ from that of method 800 is that in method 1000 when application 1028 sends 1062 second signal to Bluetooth transceiver 1006, second signal may comprise the authorization token grated by server 1036 in step 1046 and provided to application 1028 at step 1048. Once received by sensing device 1002 as part of second signal, the authorization token may then be sent at step 1066 as part of the validation request from sensing device 1002 to server 1036. Server 1036 may then process the authorization token as part of the step of processing 1070 the validation request.

In embodiments, a parking facility management system may comprise a sensing device comprising a directional Bluetooth transmitter and a Bluetooth transceiver. The directional Bluetooth transmitter may be configured to broadcast a signal in a predetermined arc corresponding to an entry and/or exit lane of the parking facility. The signal may comprise one or more received signal strength (“RSS”) signal(s), one or more tuning values, an identifier associated with said lane, and a flash ID.

As RSS signals may be affected by the location of objects in the environment around the device transmitting the RSS signal, their geometry, and the materials of which they are made, embodiments of the sensing device, and specifically the directional Bluetooth transmitter(s) may require tuning to the in-situ environment in which the sensing device is installed to provide for accurate RSS signal readings at the application, which is necessary for the application to be able to determine the proximity of the mobile device on which the application is operating to the sensing device.

The tuning values for the RSS signals may be different for correctly interacting with mobile devices running different operating systems. Therefore, there may be different tuning values for RSS signals targeted at iOS and Android devices.

The application may receive an RSS signal and use the RSS signal to determine how far the mobile device running the application is from the sensing device.

The application running on the user's mobile device may be constantly listening for unique flash IDs. If the application receives a unique flash ID from the sensing device, it may connect to a Bluetooth transceiver of the sensing device and may continue to listening to the tuning values and RSS signals being broadcasted by the sensing device. The application may even pick up the directional signals from more than one directional Bluetooth transmitter. As the mobile device running the application nears the sensing device it may make a determination, based on the RSS signals and tuning values, as to which directional signal is preferred based on the relative strengths of the RSS signals associated with each lane.

Once the application has determined the preferred directional signal, the application may transmit a signal comprising an access request and a lane identifier associated with the preferred directional signal to the Bluetooth transceiver.

Responsive to the receipt of the signal comprising an access request and lane identifier from the application, the Bluetooth transceiver may send instructions to the server and/or access controller to determine whether the contents of the request, and/or the credentials associated with the user account associated with the application sending the request, are meet the requirements necessary for the system to permit access to the parking facility. In the event of a positive determination the server may send instructions to the access controller to permit access to the parking facility. In the event of a negative determination the server may not send an instruction to the access controller or may send an instruction to the access controller to deny access to the parking facility. Further, in the event of a negative determination the server or the sensing device may transmit a notice to the application submitting the request in indicating the reason that the system did not grant/denied the access request.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of parking systems known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

To aid the Patent Office and any readers of any patent issued on this application in interpreting the claims appended hereto, the applicant wishes to note that it does not intend any of the appended claims or claim elements to invoke 35 U.S.C. 112(f) unless the words “means for” or “step for” are explicitly used in the particular claim.

We claim:

1. A parking facility access management system, comprising:
a sensing device comprising:
a directional Bluetooth transmitter configured to broadcast a first signal to a first lane of a parking facility;
and a Bluetooth transceiver;
an application running on a mobile device configured to receive the first signal, determine a lane and a proximity to the sensing device from the first signal, and to connect and transmit a second signal to the Bluetooth transceiver responsive to receipt of the first signal;
a server communicably connected to the sensing device, and configured to receive a validation request from the sensing device responsive to its receipt of the second signal, to accept or deny the validation request, and to send an access command to an access controller responsive to an acceptance of the validation request;
an access control mechanism communicably connected to the server, and configured to permit access to or from the parking facility responsive to the acceptance of the validation request by the server.

2. The system of claim 1, wherein the first signal comprises:
a flash ID;
a lane identifier;
a RSS signal; and
a tuning values.

3. The system of claim 2, wherein at least one of the RSS signal and the tuning values are tuned to an in-situ environment of the sensing device.

4. The system of claim 1, wherein the second signal comprises:
a lane identifier; and
authorization credentials.

5. The system of claim 4, wherein the authorization credentials comprise one or more of:
an authorization token;
payment information; and
user account information associated with the application;
and wherein the acceptance or denial of the validation request by the server is based on a comparison of the authorization credentials against a database of stored access authorizations.

6. The system of claim 1, wherein the parking facility access management system further comprises:
a vehicle presence detector configured to corroborate the presence of a vehicle in a location designated as relevant to the parking facility access management system.

7. The system of claim 1, further comprising an enclosure housing the directional Bluetooth transmitter, wherein the enclosure is configured to restrict an area to which the first signal is broadcast.

8. The system of claim 1, wherein the sensing device further comprises a second directional Bluetooth transmitter, wherein the second directional Bluetooth transmitter is configured to transmit an alternate first signal to a second lane of the parking facility, and wherein the alternate first signal comprises a lane identifier associated with the second lane.

9. The system of claim 1, wherein the sensing device further comprises a second Bluetooth transceiver, wherein the second Bluetooth transceiver is configured to receive an alternate second signal from a second application, wherein the sensing device is configured to send an authorization request to the application and the second application responsive to a determination that the Bluetooth transceiver received the second signal and the second Bluetooth transceiver received the alternate second signal, and further configured to send the validation request responsive to the receipt of an approval of the validation request by one of the application and the second application, wherein the validation request is based on the second signal received from the application providing the approval.

10. A method of operating a parking facility access management system comprising the steps of:
broadcasting, via a directional Bluetooth transmitter, a directional Bluetooth signal over a limited broadcast arc directed at a single lane;
receiving, via a Bluetooth transceiver, an authorization request from an application running on a mobile device and sent responsive to receipt of the directional bluetooth signal;
checking the authorization request against a database;
permitting access to/from the parking facility responsive to a positive determination of authorization.

11. The method of claim 10, wherein the directional bluetooth signal comprises
a flash ID;
a lane identifier;
an RSS signal; and
a tuning values.

12. The system of claim 10, further comprising the step of calibrating the directional bluetooth signal to an in-situ environment of the sensing device.

13. The method of claim 10, wherein the signal from the application comprises:
a lane identifier; and
authorization credentials.

14. A method of communicating with a parking facility access management system via an application operating on a mobile device, comprising the steps of:
receiving a flash ID from a directional Bluetooth transmitter;
receiving a lane identifier from the directional Bluetooth transmitter, wherein the lane identifier is associated with a specific lane of the parking facility;
receiving an RSS signal from the directional Bluetooth transmitter, wherein the RSS signal is tuned to the parking facility;
receiving tuning values from the directional Bluetooth transmitter;
determining a proximity to a sensing device based on the tuned RSS signal;
connecting to the Bluetooth transceiver based on the tuning values/flash ID;
transmitting an authorization request comprising authorization credentials and the lane identifier to the Bluetooth transceiver.

15. The method of claim 14, wherein the authorization credentials comprise one or more of
payment information; and
user account information associated with the application.

16. The method of claim 14, first comprising the steps of requesting and receiving an authorization token from a server; and wherein the authorization credentials comprises the authorization token.

17. The method of claim 14, wherein a plurality of RSS signals and tuning values are received, and wherein one or more of the plurality of tuning values and the plurality of RSS signal are selected to be used in the step of determining a proximity to the sensing device and connecting to the Bluetooth transceiver, based on at least one of the operating system running on the mobile device and its hardware.

18. The method of claim 14, further comprising the steps of receiving an approval request prior from the Bluetooth transceiver after connecting to it, and transmitting an acceptance of the approval request responsive to user input.
